(19) United States
(12) Patent Application Publication
(10) Pub. No.: US 2008/0082521 A1
(43) Pub. Date: Apr. 3, 2008

(54) Method and apparatus for information visualization and analysis

(75) Inventors: Gary R. Danielson, Kennewick, WA (US); Stuart J. Rose, Richland, WA (US)

Correspondence Address: Douglas E. McKinley, Jr., P.O. Box 202, Richland, WA, 99352, US

(73) Assignee: Battelle Memorial Institute

(21) Appl. No.: 11/541,173

(22) Filed: Sep. 28, 2006

(51) Int. Cl. G06F 17/30

(52) U.S. Cl. 707/5

(57) ABSTRACT

A method and apparatus for analyzing, organizing and manipulating data for use by computer-executable programs by performing the steps of providing a set of documents wherein each document is provided from a document source, mapping the documents to a location in multi-dimensional space wherein each document's position in multidimensional space is determined as a function of the document's relationship to other documents and is expressed as a signature for that document, identifying a unique identifier for each document, providing a graphical representation of the documents, and associating the graphical representation of each document with the document source using the unique identifier so that any manipulation of the graphical representation of the document will result in a corresponding manipulation of the document in at least one computer executable program.

The invention was made with Government support under Contract DE-AC0676RLO 1830, awarded by the U.S. Department of Energy. The Government has certain rights in the invention.

Cross Reference to related applications (if any). (Related applications may be listed on an application data sheet, either instead of or together with being listed in the specification.)

### TECHNICAL FIELD

This invention relates to analyzing, organizing and manipulating data for use by computer-executable programs. More specifically, this invention relates to methods for analyzing and visualizing natural language-based digital documents in a manner where the meaning of those documents is presented as a graphical representation, and information presented in that graphical representation is integrated with commercial software applications.

### BACKGROUND OF THE INVENTION

Virtually all aspects of the global economy have become increasingly dominated by the need for the skillful analysis of information. This skillful analysis is required in all disciplines, be they scientific, economic, industrial, or otherwise. Simultaneously, the volume of information available for analysis has rapidly expanded. This has resulted in an ever increasing value for systems or methods which are able to analyze information and separate information relevant to a particular problem or useful in a particular inquiry from information that is not relevant or useful.

The vast majority of information available for such analysis is in the form of written natural language. The traditional method of analyzing and characterizing information in the form of written natural language is to simply read it. However, this approach is increasingly unsatisfactory as the sheer volume of information outpaces the time available for manual review. Thus, several methodologies for automating the analysis and characterization of such information have arisen. Typical for such schemes is the requirement that the information is presented, or converted, to an electronic form or database, thereby allowing the database to be manipulated by a computer system according to a variety of algorithms designed to analyze and/or characterize the information available in the database. Examples of methods for organizing data structures and formatting data to enable dynamic analysis are presented in U.S. patent application Ser. No. ______ (Attorney Docket No. 15060-E (DCAF)) The entire contents of this, and all other patents, publications, or other written materials are hereby incorporated into this disclosure in their entirety by this reference.

Examples of systems that analyze data include methods that compare the contents of documents in an electronic database and thereby determine relationships between the documents. Such systems may locate documents that address similar subject matter but do not share common key words. These documents may be linked, and queries to the database are able to generate resulting relevant documents without requiring exacting specificity in the query parameters.

One method by which automated systems discern the specific words which provide insight into the meaning of the documents that contain them are neural networks or other methods to capture the higher order statistics required to compress the vector space. Vector based systems have also been developed which use higher order statistics to generate vectors based on document contents, which can in turn be used to compare documents. By measuring conditional probabilities between and among words contained within the database, different terms may be linked together.

Vector based systems have further been refined to reduce computational complexity. For example, vector based systems have been enhanced by methods whereby a sequence of word filters are used to eliminate terms in the database which do not discriminate document content. Such techniques result in a filtered word set whose members are highly predictive of content. The filtered word set may then further reduced to determine a subset of topic words which are characterized as the set of filtered words which best discriminate the content of the documents which contain them. These two word sets, the filtered word set and the topic set, may then be formed into a two dimensional matrix. Matrix entries may then be calculated as the conditional probability that a document will contain a word in a row given that it contains the word in the column of the matrix. The number of word correlations which is computed is thus significantly reduced because each word in the filtered set is only related to the topic words, with the topic word set being smaller than the filtered word set. These systems have been shown to have the ability to predict content with accuracy comparable or superior to approaches which consider word sets which have not been reduced either in the number of terms considered, or by the number of correlations between terms.

One important aspect for all of these systems is the ability to make the analysis performed by the system available to a user. Regardless of how sophisticated a particular system's algorithm is for determining or discriminating document content, the output of that system is only useful if the information can be succinctly and accurately communicated to a user. One method for making that information available to a user is described in U.S. Pat. No. 6,584,220 entitled “Three-dimensional display of document set” and issued Jun. 24, 2003 to Lantrip et al. (the “220 patent”).

The 220 patent describes a method for spatializing text content for enhanced visual browsing and analysis. As described in the 220 patent, the text content from sources such as digital libraries, regulations and procedures, archived reports, and the like, is transformed into a spatial representation that preserves informational characteristics from the documents. The three-dimensional representation may then be visually browsed and analyzed in ways that avoid language processing and that reduce the analysts' effort.

More specifically, the 220 patent describes a method of determining and displaying the relative content and context of a number of related documents in a large document set. The relationships of a plurality of documents are presented in a three-dimensional landscape with the relative size and height of a peak in the three-dimensional landscape representing the relative significance of the relationship of a topic, or term, and the individual document in the document set. The steps of the process are: (a) constructing an electronic database of a plurality of documents to be analyzed; (b) creating a plurality of high dimensional vectors, one for each of the plurality of documents, such that each of the high dimensional vectors represents the relative relationship of the individual documents to the term, or topic attribute; (c) arranging the high dimensional vectors into clusters, with each of the clusters representing a plurality of documents grouped by relative significance of their relationship to a topic attribute; (d) calculating centroid coordinates as the center of mass of each cluster, the centroid coordinates being stored or projected in a two-dimensional plane; (e) constructing a vector for each document, with each vector containing the distance from the document to each centroid coordinate in high-dimensional space; (f) creating a plurality of term (or topic) layers, each of the term layers corresponding to a descriptive term (or topic) applied to each cluster, and identifying x,y coordinates for each document associated with each term layer; and (g) creating a z coordinate associated with each term layer for each x,y coordinate by applying a smoothing function to the x,y coordinates for each document, and superimposing upon one another all of the term layers.

While the methods for analyzing and visualizing information described above have significantly enhanced the ability of the user to analyze, understand and utilize information contained within large amounts of digital data, these methods still suffer from certain drawbacks. For example, the methods and systems described in this background section typically exist as stand-alone systems. As with most stand alone automated systems, users of these systems face a steep learning curve. At the same time, large numbers of computer users are familiar with standard, commercially available software packages such as e-mail software, spreadsheet software, and word processing software used for performing common tasks. Millions of users are adept at manipulating electronic information in these existing software packages. However, to date they have been unable to utilize their skills with these pre-existing software programs to take advantage of the new analytical capabilities described above. Therefore, there exists a need to integrate advanced analysis and visualization techniques with commonly used software packages. The present invention fulfills that need.

### SUMMARY OF THE INVENTION

One object of this invention is therefore to provide advanced analytical capabilities into the commercially available software packages used by the everyday information worker to accelerate the exploration, management, and analysis of large datasets. The present invention provides a framework that facilitates combining new algorithms that extract knowledge signatures from data with the analytical capabilities provided by commercial desktop software applications. The present invention thus allows users to discover new relationships in their data, combine these relationships with other more accessible relationships, and manipulate the original data according to the relationships.

It is a further object of the present invention to provide a system that extracts affectivity, concepts, and/or major themes from unstructured text fields in a relational database or spreadsheet which can be combined with the structured fields to gain new insight. It is yet another object of the present invention to provide this integration with desktop applications while eliminating the learning curve and difficulties associated with data import in prior art, stand alone data analysis programs.

It is yet another object of the present invention to provide a method for analyzing, organizing and manipulating data for use by computer-executable programs, including but not limited to, Microsoft Windows, Microsoft Office, Lotus Notes, Analyst Notebook that is integrated with those computer-executable programs and leverages the capabilities of the those computer-executable programs. For example, and not meant to be limiting, the use of the present invention in conjunction with a spreadsheet such as Microsoft Excel allows the user to extend the advanced features within Excel by analyzing the thematic data derived by the algorithms back into the spreadsheet. The present invention thus uses familiar interaction techniques which have become intuitive to users. For example, and not meant to be limiting, Desktop Tools for Windows can drag and drop files into the display of the present invention, allowing the user to view the key themes and their relationships, and instruct the present invention to reorganize the files thematically. The present invention in combination with Excel can thus copy clusters of data to a new worksheet and create pivot tables. When used in combination with a commercial e-mail client, for example, and not meant to be limiting, such as Microsoft Outlook, the present invention facilitates the organization of emails into folders and can place incoming emails into the appropriate folder.

These and other objects of the present invention are accomplished by providing a method and apparatus for analyzing, organizing and manipulating data for use by computer-executable programs. As an apparatus, the present invention is provided in the form of a computer system that can perform the method of the present invention, or a computer readable medium that can be used to configure a computer system to perform the method of the present invention. Whether provided as a method, a computer system, or a computer readable medium that has configured a computer system, the present invention performs the steps of providing a set of documents wherein each document is provided from a document source, mapping the documents to a location in multi-dimensional space wherein each document's position in multidimensional space is determined as a function of the document's relationship to other documents and is expressed as a signature for that document, identifying a unique identifier for each document, providing a graphical representation of the documents, and associating the graphical representation of each document with the document source using the unique identifier so that any manipulation of the graphical representation of the document will result in a corresponding manipulation of the document in at least one computer executable program. As will be apparent to those having ordinary skill in the art, the step of mapping the documents to a location in multidimensional space can be accomplished by a variety of techniques, including, but not limited to, vector based approaches, statistical techniques, artificial intelligence, neural networks, and support vector machines. Examples of methods for organizing data structures and formatting data to enable the analysis of the present invention are presented in U.S. patent application Ser. No. ______ (Attorney Docket No. 15060-E (DCAF))

In one embodiment of the present invention, the step of mapping the documents to a location in multi-dimensional space wherein each document's position in multidimensional space is determined as a function of the document's relationship to other documents is accomplished by creating high dimensional vectors for each of the documents, such that each high dimensional vector represents the relative relationship of the individual documents a term or topic attribute and arranging the high dimensional vectors into clusters, with each of the clusters representing a plurality of documents grouped by relative significance of their relationship to a topic attribute. In this embodiment, the unique signatures may be optimized to provide an optimum number of clusters. In another embodiment, each document comprises data in a tabular form having a plurality of rows, each row having a plurality of columns. In this embodiment, each document comprises all or part of a row.

### DETAILED DESCRIPTION OF THE PREFERRED EMBODIMENTS

For the purposes of promoting an understanding of the principles of the invention, a preferred embodiment of the present invention was programmed and reduced to practice. This embodiment of the present invention coupled a signal generator, such as that described in U.S. Pat. No. 6,484,168 entitled “System for Information Discovery” issued Nov. 19, 2002 (hereafter the SID generator), with a computer-executable program, preferably a commercially available software package or “application.”

The underlying architecture for any implementation of the present invention is the same regardless of the application (such as Microsoft Excel or Outlook) and regardless of the signature generator (such as the SID generator). The present invention is preferably integrated within an application as a “plug-in” extension. The hosting application preferably supports extension using a published application programming interface. As used herein, the word ‘document’ does not necessarily mean text or written form. It could consist of a series of numbers or categories that taken in total “document” a state or situation. Further, a “document” could include a portion of a written text.

Preferred applications interfaced with the present invention are characterized by the following traits; They manage data and metadata (data about the data). the data consists of structured and/or categorical data and unstructured data such as freeform text or numbers representing a state, such as time, temperature, speed, etc., they display data and metadata to the user, they allow the user to manipulate the data or sets of data, and they support an application programming interface which some or all of the following: the ability to access source documents, the ability to add metadata to documents, the ability to manipulate the location of the document, the ability to view the document in it's original form, the ability to detect a user selecting set of documents, the ability to programmatically select a set or subset of these documents, and the ability to identify each document using a unique identifier

The general process for a user to the present invention in a host application is as follows. When the host application is started, it detects that a plug-in is available and makes that plug-in option available to the user by adding one or more windows buttons or menu items. The present invention can also be invoked upon an action the user takes without requiring that the buttons or menu items be accessed. These actions would have been requested by the user. The present invention preferably does not take actions without the user first invoking those actions.

When the user presses the button, the present invention is notified of the request. The action is usually a request to “process” a set of “documents,” which, as previously explained, can be files, rows, emails etc. the present invention qualifies the user's request by insuring that a minimum set of documents has been selected, and provides the user with processing choices. These processing choices include but are not limited to the type of processing required. The present invention preferably has a feature to perform pre-analysis on the data allowing the present invention to recommend a process, such as selecting which metadata to include in the processing, if necessary, the metadata to include in processing, and the parameters required for the types of processes requested.

Once the user has provided some feedback the present invention processes the information. For example, and not meant to be limiting, if the user requests that the present invention process a set of Excel rows containing unstructured text in some columns and a set of associated metadata in other columns, the process requested is one that measures the proximity of one document to another using corpus level differentiating terms (SID).

Regardless of the process requested, the present invention prepares the information in the following manner. The present invention contains a framework in which the data can be pre-analyzed so as to suggest to the user the best course of analysis. Each process model, the present invention supports may contain a description for evaluation of applicability to the dataset being provided. The present invention uses this description to make suggestions based on this information. Present invention samples the corpus looking for applicability to the known and supported processes for that version of the present invention. This can consist of, but is not limited to, the nature of the data such as numeric, text, size, structure. It can also include results of a preliminary analysis of the data such as information distribution, correlation, and covariance.

Each document is then tracked by a unique identifier. This is supplied by the hosting application and has meaning to the application. The unstructured text of the document is transformed into an integer array with each array member's value representing a unit of text in the order of the original document. A unit of text could be a word, phrase, phonetic signature. Each array member value has an associated entry in a glossary which can be used to look up the original text. The length of the array (document vector) is representative of the length of the document and some level of compression of the original text is established.

The requested metadata (or attributes) for the document is processed in a similar manner. The width of the integer array (attribute vector) needed to support the attributes for a document is fixed in accordance with the number of requested attributes the user wishes to track. Although, usually a fixed set of attributes is tracked for each document, there is nothing to prevent the present invention from tracking a set of attributes where each document could have a different number of attributes. The document and attribute vector are then combined along with the unique document identifier to produce the default processing vector.

In one embodiment of the present invention, the present invention can perform additional preparation on the default processing vector. For example, and not meant to be limiting, the present invention may be configured to aggregate vectors. This combines the document vectors of one or more documents based on attribute vector values so as to create a new aggregated document. Processing can then be done on the aggregated document. For example, and not meant to be limiting, if each document had an author and year attribute, aggregation could be used to synthesize documents which represent the combined documents or an author, year or author in a year. In this case the synthesized document only contains the attributes used for aggregation and the unique identifier for this document becomes the set of unique identifiers for the documents aggregated into the synthesized document.

Another example of additional preparation that can be performed on the default processing vector is bifurcation. This takes a default processing vector and splits the document vector portion based on the preparation requested. This could include splitting a document by paragraph or page or the original document could be split by a change in topic. This results in the default processing vector being expanded to one or more processing vectors where the document vector portion is a segment from the original document and the attribute vector is identical to the attributes for the original document.

The unique identifier may also be expanded to include a segment identifier. For example, and not meant to be limiting, the present invention can do phrase detection where the process for corpus level preparation is the same. Phrase detection may be at the corpus level or the document level. At the document level, the phrase detection is preferably done when building the document vector. If the user requests, once the document vectors are built, the present invention can go through the corpus and treat the corpus as one document. Using the same phrase detection step, phrases are detected at the corpus level versus the document level. Once a phrase has been detected, it is added to the glossary and its code is used to replace two or more discrete words in each document vector. The present invention can preferably save and reload all of the information from the preparation phase. At this point, and for any point forward, the present invention can record the current state or version of the prepared data and save. This allows the present invention to make adjustments to data structures and always know that any version of the prepared data can be recalled.

The present invention is preferably configured to support inclusion of processes that deal with documents containing unstructured data, numeric data and metadata. Examples of such processes are presented in U.S. patent application Ser. No. ______ (Attorney Docket No. 15060-E, and the present invention is preferably integrated with the Deep Center analytical foundation described therein. In addition, processes requiring structured information associated with the document, such as the SID process and the concept based clustering process, are preferably supported.

The present invention is preferably configured to invoke multiple processes on a single data set. There is nothing in the framework that expects that the processes running concurrently or sequentially. The present invention preferably is configured to support either. In the case of sequential processes the functions available at the end of the preparation phase above may apply. For example, and not meant to be limiting, the thread of data continuity may become the unique identifier.

During processing the present invention can preferably monitor the progress of processing, display the processing errors, and allow the user to cancel processing. These steps are readily accomplished if the process has the capabilities of generating events, setting flags or other well known methods for monitoring.

The present invention preferably allows the state of the process engine to be saved at any state for any reason. Just as the present invention is preferably configured with the capability to save the state in the preparation phase, present invention is preferably configured to save the state of the processing engine so that adjustments can be made to the process and later recalled to a known state.

Although some engines provide an interactive API in which the process engine state can be interrogated after processing, present invention can also preferably support those processing engines that providing a static set processing results. The private present invention is thereby configured to operate with any process that will return, at a minimum, a signature for each document. It is also preferred that the document signatures will be accompanied by corpus level data structures. The present invention preferably captures the results and those results can be used by the present invention to provide process interrogation functionality.

In general, the results of processing will be a set of signatures that can be used to create an alternative representation of the data. Preferably, the processing would identify features and then provide a classification or categorization of those features as a set of signatures. A typical representation of these signatures would be in a visualization, but a visualization is not required. After processing, the present invention maintains a relationship between actions taken by the host application (if supported) and actions taken by the present invention on the corresponding representation of that data (actionable representation). The present invention preferably wraps each piece of actionable information in an event envelope which creates signals upon any action on that item. These events include but are not limited to selection—the user selects the information, click—the user clicks or double clicks on a visual representation of the data, hovering or mouse over—the user runs the mouse over a visual representation of the information, and information actions including, but not limited to, Delete, Change in location, Change in metadata. The present invention preferably allows custom actions to take place in the hosting application with each event. The actual action is dependant on the process engine, visualization, data and hosting application.

To assist the User in analyzing complex data, in many cases the current invention can use signatures from the process along with metadata from the original context to provide some level of automated computer aided analysis by looking for patterns between the signatures from the processing and metadata or derivates of the metadata. Any pattern matching algorithm would be included in the term “computer aided analysis” as used herein. A typical example would be to look for correlation between a piece of metadata such as location or date and a signature signifying a category assigned to unstructured text.

The present invention preferably provides a set of calls that can be used by the application developers from within applications that support exposure of the present invention's APIs. Using the present invention's APIs, an Excel user, for example, and not meant to be limiting, can call all of the functionality provided by the present invention using, for example, “Visual Basic for Applications” (VBA) or an equivalent. All of the main functionality of the present invention can be customized by the VBA programmer so that VZIN can be made to do things in accordance with the way the VBA programmer wants them done.

While the invention has been described in connection with specific embodiments utilized for the project undertaken to demonstrate a preferred embodiment of the present invention, those having ordinary skill in the art will readily that many changes and modifications may be made without departing from the invention in its broader aspects. The appended claims are therefore intended to cover all such changes and modifications as fall within the true spirit and scope of the invention.

The invention claimed is:

1. A method for analyzing, organizing and manipulating data for use by computer-executable programs comprising the steps of:
providing a set of documents, wherein each document is provided from a document source
mapping the documents to a location in multi-dimensional space wherein each document's position in multidimensional space is determined as a function of the document's relationship to other documents and is expressed as a signature for that document,
identifying a unique identifier for each document
providing a graphical representation of the documents
associating the graphical representation of each document with the document source using the unique identifier so that any manipulation of the graphical representation of the document will result in a corresponding manipulation of the document in at least one computer executable program.

2. The method of claim 1 wherein the step of mapping the documents to a location in multi-dimensional space wherein each document's position in multidimensional space is determined as a function of the document's relationship to other documents is accomplished by the steps of
creating high dimensional vectors for each of the documents, such that each high dimensional vector represents the relative relationship of the individual documents a term or topic attribute; and
arranging the high dimensional vectors into clusters, with each of the clusters representing a plurality of documents grouped by relative significance of their relationship to a topic attribute.

3. The method of claim 2 wherein said unique signatures are optimized to provide an optimum number of clusters.

4. The method of claim 1 wherein each document comprises data in a tabular form having a plurality of rows, each row having a plurality of columns.

5. The method of claim 4 wherein each document comprises at least a portion of a row.

6. An apparatus for analyzing, organizing and manipulating data for use by computer-executable programs comprising a computer system configured to perform the steps of:
inputting a set of documents, wherein each document is provided from a document source,
mapping the documents to a location in multi-dimensional space wherein each document's position in multidimensional space is determined as a function of the document's relationship to other documents and is expressed as a signature for that document,
identifying a unique identifier for each document,
providing a graphical representation of the documents,
associating the graphical representation of each document with the document source using the unique identifier so that any manipulation of the graphical representation of the document will result in a corresponding manipulation of the document in at least one computer executable program running on said computer system.

7. The apparatus of claim 6 wherein the step of mapping the documents to a location in multi-dimensional space wherein each document's position in multidimensional space is determined as a function of the document's relationship to other documents is accomplished by the steps of
creating high dimensional vectors for each of the documents, such that each high dimensional vector represents the relative relationship of the individual documents a term or topic attribute; and
arranging the high dimensional vectors into clusters, with each of the clusters representing a plurality of documents grouped by relative significance of their relationship to a topic attribute.

8. The apparatus of claim 7 wherein said unique signatures are optimized to provide an optimum number of clusters.

9. The apparatus of claim 6 wherein each document comprises data in a tabular form having a plurality of rows, each row having a plurality of columns.

10. The apparatus of claim 9 wherein each document comprises at least a portion of a row.

11. A computer readable medium having computer-executable instructions for performing a method for analyzing, organizing and manipulating data for use by other computer-executable programs comprising the steps of:
providing a set of documents, wherein each document is provided from a document source
mapping the documents to a location in multi-dimensional space wherein each document's position in multidimensional space is determined as a function of the document's relationship to other documents and is expressed as a signature for that document,
identifying a unique identifier for each document
providing a graphical representation of the documents
associating the graphical representation of each document with the document source using the unique identifier so that any manipulation of the graphical representation of the document will result in a corresponding manipulation of the document in at least one computer executable program.

12. The computer readable medium having computer-executable instructions of claim 11 wherein the step of mapping the documents to a location in multi-dimensional space wherein each document's position in multidimensional space is determined as a function of the document's relationship to other documents is accomplished by the steps of
creating high dimensional vectors for each of the documents, such that each high dimensional vector represents the relative relationship of the individual documents a term or topic attribute; and
arranging the high dimensional vectors into clusters, with each of the clusters representing a plurality of documents grouped by relative significance of their relationship to a topic attribute.

13. The computer readable medium having computer-executable instructions of claim 12 wherein the unique signatures are optimized to provide an optimum number of clusters.

14. The computer readable medium having computer-executable instructions of claim 11 wherein each document comprises data in a tabular form having a plurality of rows, each row having a plurality of columns.

15. The computer readable medium having computer-executable instructions of claim 14 wherein each document comprises at least a portion of a row.

16. A system for analyzing, organizing and manipulating data for use by computer-executable programs comprising:
an input device configured to receive a set of documents, wherein each document is provided from a document source,
a processor configured to:
map the documents to a location in multi-dimensional space wherein each document's position in multidimensional space is determined as a function of the document's relationship to other documents and is expressed as a signature for that document,
identify a unique identifier for each document,
provide a graphical representation of the documents,
associate the graphical representation of each document with the document source using the unique identifier so that any manipulation of the graphical representation of the document will result in a corresponding manipulation of the document in at least one computer executable program.

17. The system of claim 16 wherein the processor is configure to map the documents to a location in multi-dimensional space wherein each document's position in multidimensional space is determined as a function of the document's relationship to other documents by
creating high dimensional vectors for each of the documents, such that each high dimensional vector represents the relative relationship of the individual documents a term or topic attribute; and
arranging the high dimensional vectors into clusters, with each of the clusters representing a plurality of documents grouped by relative significance of their relationship to a topic attribute.

18. The system of claim 17 wherein the processor is configured so that the unique signatures are optimized to provide an optimum number of clusters.

19. The system of claim 16 wherein the processor is configured so that each document comprises data in a tabular form having a plurality of rows, each row having a plurality of columns.

20. The system of claim 19 wherein each document comprises at least a portion of a row.
